(19) United States
(12) Patent Application Publication
(10) Pub. No.: US 2020/0394002 A1
(43) Pub. Date: Dec. 17, 2020

(54) PRINTING UTILIZING QUALITY DATA FOR PRINTED TARGET AREAS

(71) Applicant: Hewlett-Packard Development Company, L.P., Spring, TX (US)

(72) Inventor: Jaime Abel Blanco Gabella, Sant Cugat del Valles (ES)

(73) Assignee: Hewlett-Packard Development Company, L.P., Spring, TX (US)

(21) Appl. No.: 16/605,819

(22) PCT Filed: Mar. 8, 2018
(86) PCT No.: PCT/US2018/021547

§ 371 Date: Oct. 17, 2019

(51) Int. Cl. G06F 3/12; G06K 15/22

(52) U.S. Cl. CPC G06F 3/1208; G06F 3/1252; G06F 3/1256; G06K 15/22

(57) ABSTRACT

In one example of the disclosure, a plot to be printed at a digital printer is received. A designation of a target area of the plot is received. A first printing is caused. The first printing is a printing of the target area without printing non-target areas of the plot. Quality data indicative of the quality of the printed target area is received. If the indicated quality is above a predefined threshold, a second printing is caused resulting in printing of the entire plot.

### BACKGROUND

A print system may apply print agents to a paper or another substrate to produce an image on the substrate. One example of a print system is a web-fed print system, which applies the print agents to a web substrate fed to the print system by a substrate roll feeder system. After application of the print agents, the printed upon substrate may be collected on a re-winder drum or cut into sheets. Another example of a print system is a sheet fed print system, which applies the print agents to a sheet substrate rather than a continuous web. In certain examples, print systems may apply a print agent that is an electrostatic printing fluid (e.g., electrostatically chargeable toner or resin colorant particles dispersed or suspended in a carrier fluid). Such systems are commonly referred to as LEP printing systems. In other examples, the print agent may be applied via inkjet or dry toner printing technologies.

### DRAWINGS

FIG. 1 illustrates an example of a system or printing utilizing quality data for printed target areas.

FIG. 2 illustrates another example of a system for printing utilizing quality data for printed target areas.

FIG. 3 is a block diagram depicting a memory resource and a processing resource to implement an example of a method to print a plot in consideration of quality data for a printed target area.

FIGS. 4A, 4B, 4C, 5A, 5B, and 5C illustrate an example of printing utilizing quality data for printed target areas.

FIG. 6 is a flow diagram depicting implementation of an example of a method to print utilizing quality data for printed target areas.

### DETAILED DESCRIPTION

Regardless of the type of print system used (web-fed, sheet-fed, LEP, inkjet, dry toner, etc.) print quality can be affected be affected by many variables. Even a small deviation of a print system component's condition or performance relative to an expected condition or performance can significantly affect print quality. For instance, any one or more of an unexpected media position, speed of media movement, image registration, color registration, print engine component condition or performance (e.g., a LEP developer unit, a LEP intermediate transfer member, an inkjet printhead, a drying unit, etc.) can negatively affect print quality. In other situations, a print system may be working correctly, yet a change in the printing environment (temperature, humidity, level of dust, etc.) results in print output that is inferior compared to the expected output. In other situations, the print system performance and the environment may both be as expected, yet a defect in a substrate or the print agent can result in a print quality that does not meet user expectations. In yet other situations, printed output may be deemed to be of poor quality even where the print system, substrate, and print agent are all are without errors, e.g., due to a choice of an incorrect substrate or print agent for the particular job.

Some print quality issues can be automatically detected by the print system. For instance, certain print systems may detect a print system component discrepancy or an environmental discrepancy compared to what is expected and respond accordingly. In examples, such response may be to provide a message to a user, to perform a calibration operation, or to suspend printing until a user operation occurs (e.g., an operation to replace a defective or worn component).

However, in many situations (e.g., where the plot to be printed is complex, where exact color matching is needed, where printed output has an extremely high importance, etc.) it may be advantageous to print on the substrate to create a test printout and assess the quality of the test printout itself versus relying solely on automated print quality or component error detection systems. Existing systems and methods that include real-time viewing of printouts to determine quality can cause costly delays to production printing and can be in expensive in term of consumables used. For instance, an example plot to be printed may have a complex or high-significance first portion that is 25% of the area of the entire plot, and have a second portion or multiple portions make up 75% of the area of the entire plot and are less complex or significant. Using existing systems and methods, a print system would typically print the entire plot for visual or system inspection, including printing the 75% for which no significant errors are expected. Such printing of areas where errors are not expected or are not significant can be a large source of expense in terms of consumables used (including, but not limited to print agent and substrate), wear on print system components, and the time needed for producing test prints that can delay production printing.

To address these issues, various examples described in more detail below provide a system and method for print utilizing quality data for printed target areas. In an example, the disclosed system is to receive a plot to be printed at a digital printer. The system is to further receive a designation of a target area of the plot. The system is to cause a first printing that is a printing of the target area, without printing non-target areas of the plot. The system is to receive quality data indicative of the quality of the printed target area. If the indicated quality is above a predefined threshold, the system is to cause a second printing that results in printing of the entire plot. In examples, if the indicated quality is below a predefined threshold, the system may perform a corrective action to improve the quality.

In a certain example, causing first printing includes leaving unprinted space on the substrate for a subsequent printing of the non-target areas of the plot. In this example, the system is to cause the printer to position the substrate for the second printing, wherein causing the second printing includes printing the non-target areas without printing in the target area. In examples, the system may cause the first printing to include printing a fiducial upon the substrate, and the system may cause the printer to position the substrate for the second printing utilizing an optical sensor to detect the fiducial.

In other examples, if the received quality data is indicative that the printed plot quality is above a predefined threshold, the system is to, rather than causing a second printing that completes the plot, cause a second printing operation that results in a new printing of the entire plot without incorporating printed material from the first printing.

In an example, the disclosed system may include a user interface for a user to use to designate a target area in a plot, and the system is to receive the designation of the target area via the user interface. In another example, the designation of a target area in the plot is a designation is to be made by an application or program according to predefined criteria for the target area. In this latter example, the system is to receive the designation of the target area via this application or program.

In certain examples, the quality data, indicative of the quality of the printed target area that is received by the system, is data provided by a user via a user interface. In a particular example, the system may receive quality data wherein the quality data is indicative of a user assessment that that the printed plot quality is at or above satisfactory. In other examples, rather than receiving a user assessment of quality, the system may receive quality data that results from utilization of a camera (e.g., an in-line spectrophotometer) to capture an image of the printed plot. In these examples, the quality data may be created by a comparison of a measured value of the captured image with an expected value for the captured image.

In this manner users of the disclosed system and method should appreciate the inherent savings provided and enhanced customer satisfaction. In many circumstances a user will have knowledge, or the system will have information, even before printing of a plot has begun as to which are the key or most complicated areas of the plot. The disclosed system and method utilizes this information to accelerate the final defect detection process for these target areas, skipping printing of the non-target areas of the plot where there is more confidence that printing will be achieved without defect. The savings provided will include savings in time, media, ink and other consumables, Users of the disclosed system and method will be able determine in advance of production printing, e.g., by human inspection or analysis utilizing a camera, the quality of the printing to occur in the target areas, Manufacturers and providers of print systems will likewise enjoy the competitive benefits of offering the printing system and printing method described herein.

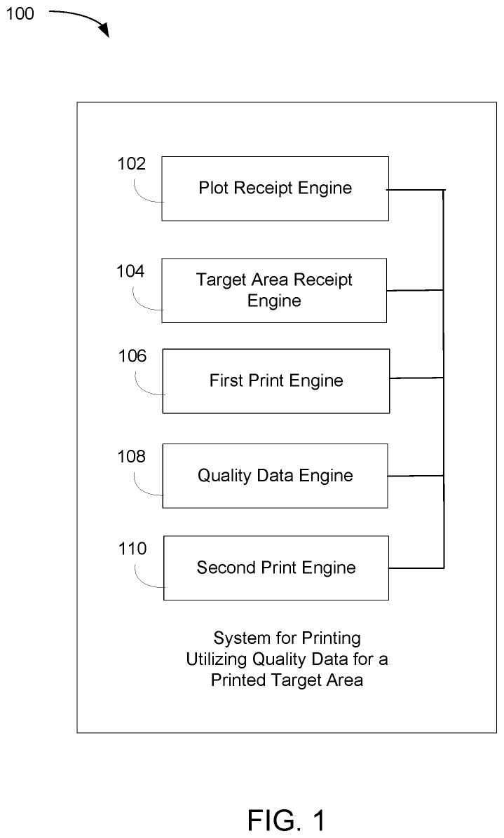

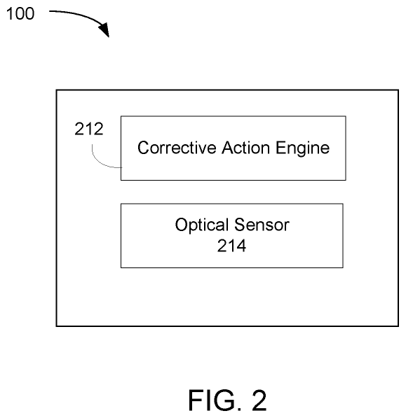

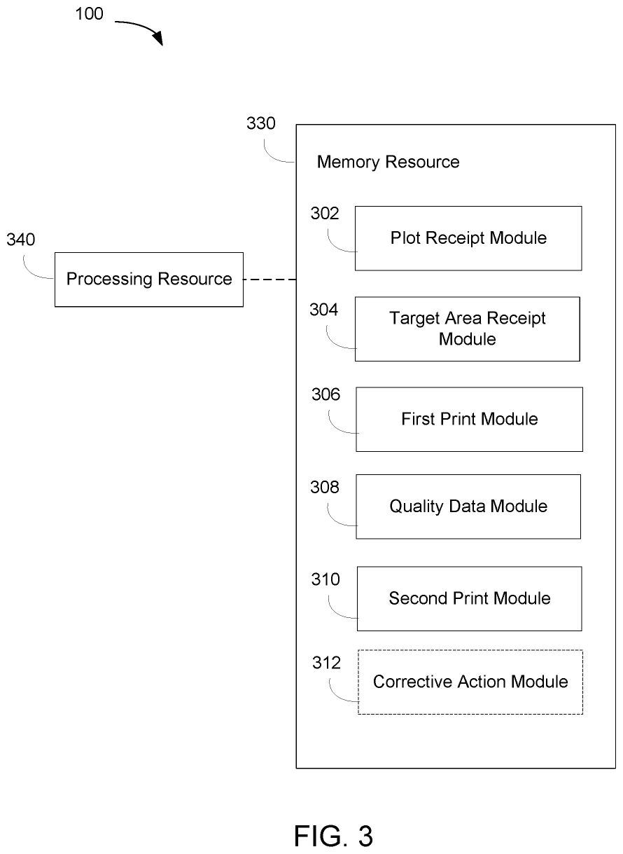

FIGS. 1-3 depict examples of physical and logical components for implementing various examples. In FIGS. 1 and 2 various components are identified as engines 102, 104, 106, 108, 110, and 212. In describing engines 102-212 focus is on each engine's designated function. However, the term engine, as used herein, refers generally to hardware and/or programming to perform a designated function. As is illustrated with respect to FIG. 3, the hardware of each engine, for example, may include one or both of a processor and a memory, while the programming may be code stored on that memory and executable by the processor to perform the designated function.

FIG. 1 illustrates an example of a system 100 for printing utilizing quality data for a printed target area. In this example, system 100 includes a plot receipt engine 102, a target area receipt engine 104, a first print engine 106, a quality data engine 108, and a second print engine 110. In performing their respective functions, engines 102-110 may access a data repository, e.g., a memory accessible to system 100 that can be used to store and retrieve data.

In an example, plot receipt engine 102 represents generally a combination of hardware and programming to receive a plot be printed at a digital printer. As used herein a “plot” is used synonymously with an “image”, and refers to a representation or rendering of an object, scene, person, or an abstraction such text or a geometric shape. In examples the plot may be received in a raster or vector format. In examples, the plot may be in a compressed or an uncompressed format. Examples of possible formats for the plot include JPG (Joint Photographic Experts Group), TIFF (Tagged-Image File Format), BMP (Windows Bitmap), PNG (Portable network Graphics), EPS Encapsulated Post-Script), PDF (Portable Document Format), and PS (PostScript). As used herein, a “digital printer” refers generally to any liquid inkjet printer, solid toner-based printer, liquid toner-based printer, or any other electronic device that is to print a plot. “Digital printer” includes any multifunctional electronic device that performs a function such as scanning and/or copying in addition to printing.

Target area receipt engine 104 represents generally a combination of hardware and programming to receive a designation of a target area of the plot. In one example, target area receipt engine 104 may provide a display of the plot and a graphic user interface (“GUI”) or other user interface at a digital printer, or another computing device, such as a mobile computing device or notebook computer that shares a network connection with a digital printer. In this example, the target area designation received by target area receipt engine 104 is a user designation received by target area receipt engine 104 via the user interface. In an example, the user may use a touchpad, a mouse, other pointing device to designate the target area as a subset of the total area of the displayed plot.

In another example, the target area may be a designation made by an application according to predefined criteria for the target area. In an example, the application may designate the target area according to criteria that has been provided by a user utilizing a user interface. For instance, the application may select one or more target areas utilizing user-provided criteria such as
areas with a color uniformity larger than X square inches, or
   areas with a color gradient of DeltaE/inch, or
      areas with details smaller than X area.
         Other examples of user-defined criteria are contemplated by this disclosure. As used herein, an “application” refers generally to programming that executes at, or accessible at, a computing device to enable a user to perform a group of coordinated functions, tasks, or activities. In examples, an application may be an application that executes at a notebook computer, desktop computer, mobile computing device or other personal computing device. In other examples, an application may be a web application that executes at, or may be a web application accessible, at a personal computer. As used herein, a “web application” refers generally to an application that is coded in a browser-supported language (such as XML, HTML, or HTML with JavaScript) and is reliant on a web browser application to render the application executable or presentable. In other examples, an application may be a may be a rich client application. As used herein, a “rich client application” refers generally to an application executing in a computing device that that retrieves data via the Internet. As used herein, “computer” is used synonymously with “computing device,” and may be, but is not limited to, a desktop computer, workstation, mobile computing device, and/or other processing device or equipment.

First print engine 106 represents generally a combination of hardware and programming to cause a first printing that is a printing of the designated target area, while leaving unprinted space on the substrate for subsequent printing of the non-target areas of the plot.

Quality data engine 108 represents generally a combination of hardware and programming to receive quality data indicative of the quality of the printed target area. In one example, the quality data may be data that is provided to quality data engine 108 by virtue of a user interaction with a user interface (e.g., a mouse, a pointer, a touchscreen etc.). In an example, the user may have provided the quality data after having performed a visual evaluation of the printed target area, without utilizing special tools. In another example, the user may have provided the quality data after having performed an evaluation of the printed target area utilizing a spectrophotometer or other equipment.

In another example, quality data engine 108 may utilize a spectrophotometer or other camera at the digital printer to capture an image of the printed plot and determine a measured value for the captured image.

Second print engine 110 represents generally a combination of hardware and programming to, if the indicated quality is above a predefined threshold, position the substrate for a second printing. Where the quality is determined to be insufficient, e.g., below the predefined threshold, the first printing can be cut (e.g., in the case of a web substrate) or otherwise removed from the printer for disposal or for additional quality testing.

In one example, the indication that the indicated quality is above a predefined threshold may be a receipt of a user-provided communication that the quality of the inspected plot is satisfactory, or above satisfactory. In another example, second print engine 110 may determine the indicated quality of the target area is above a predefined threshold by having compared the measured value of the printed target area (e.g., a measured value obtained via a camera) with an expected value for the target area. In examples, second print engine 110 may access the expected value for the captured image at a lookup table or at a database.

In one particular example, the first printing includes leaving unprinted space on the substrate for a subsequent printing of the non-target areas of the plot. In this example second print engine 110 causes the printer to position the substrate for the second printing. The second printing includes printing the non-target areas without printing in the target area. In this manner, the first printing is not disposed of. The result of the combination of the first printing of the target areas of the plot and the second printing of non-target areas of the plot is printing of the entire plot, without an overprinting of the target areas.

In a particular example, the first printing includes printing one or more fiducials upon the substrate. As used herein, a “fiducial” refers generally to a rectangle, an oval, a line segment, dot, spot, cross, or other geometrical shape or other visual feature that may be placed in the focal plane of a sensor and used as a reference point for measuring a distance. In this particular example, second print engine 110 is to utilize an optical sensor 214 (FIG. 2) to detect the one or more of the printed fiducials and use the detected fiducials to position the substrate for the second printing. In examples, the positioning may include reversing of the substrate (e.g., a web substrate or a sheet substrate) to position the substrate for the second printing. If the substrate is a sheet substrate, the positioning may include reinsertion of the sheet into the printer and subsequent alignment by the printer

In yet another particular example, plot receipt engine 102 is to receive a first plot to be printed at a digital printer. In this example, target area receipt engine 104 is to receive a designation of multiple target areas of the plot (e.g., a first target area and a second target area). In this example, first print engine 106 is to cause a first printing that is a condensed, disposable printing of the multiple target areas, without printing any non-target areas of the plot. In this example, the first printing includes creating and printing a second plot that includes the multiple selected target areas of the first plot printed adjacent to one another. By causing the multiple selected target areas to be printed adjacent to one another as a second plot, the condensed, disposable first printing of the multiple target areas enjoys a saving of time and resources (e.g., ink and substrate) as compared to printing the multiple target areas on a plot in their original positions of the first plot. In this example, quality data engine 108 is to receive quality data indicative of the quality of the printed multiple target areas printed in the condensed, disposable first printing.

In this particular example, second print engine 110 is to, if the indicated quality of the first printing is above a predefined threshold, cause a second printing that is a production printing resulting in printing of the entire first plot. In this production printing the multiple target areas are printed with positioning as established in the first plot. In this example, where the first printing is a disposable printing with target areas printed adjacent to one another, the first printing may be at test strip that can be cut (e.g., in the case of a web substrate) or otherwise removed from the printer and discarded after the test, regardless of whether the quality is above or below the predefined threshold.

Moving to FIG. 2, in certain examples system 100 may include a corrective active engine 212. Corrective active engine 212 represents generally a combination of hardware and programming to, if the indicated quality received by quality data engine 108 is below a predefined threshold, perform a corrective action to improve the quality of printing of the target area. In an example, the indication that the indicated quality is below a predefined threshold may be a receipt of a user-provided communication that the quality of the inspected plot is not satisfactory. In another example, corrective action engine 212 may determine the indicated quality of the target area is below a predefined threshold by having compared the measured value of the printed target area (e.g., a measured value obtained via a camera) with an expected value for the target area. In examples, corrective action engine 212 may access the expected value for the captured image at lookup table or at a database.

In examples, the corrective action may be any printer operation that improves print quality. In an example, a corrective action may be to cause a color correction operation (including, but not limited to a print agent placement or print agent density correction) at the printer. Other example corrective actions include performing a service operation. Other example corrective actions include adjusting a parameter for a printer component (including but not limited to a printhead, a drying component, a media handling component, a photoconductor component, a developer component, a writing component, a blanket, and/or charging component). Another example of a corrective action is to cause a switching of inks or substrates to positively affect the quality of printing of the target area.

In the foregoing discussion of FIGS. 1 and 2, engines 102-212 were described as combinations of hardware and programming. Engines 102-212 may be implemented in a number of fashions. Looking at FIG. 3 the programming may be processor executable instructions stored on a tangible memory resource 330 and the hardware may include a processing resource 340 for executing those instructions. Thus, memory resource 330 can be said to store program instructions that when executed by processing resource 340 implement system 100 of FIGS. 1 and 2.

Memory resource 330 represents generally any number of memory components capable of storing instructions that can be executed by processing resource 340. Memory resource 330 is non-transitory in the sense that it does not encompass a transitory signal but instead is made up of a memory component or memory components to store the instructions. Memory resource 330 may be implemented in a single device or distributed across devices. Likewise, processing resource 340 represents any number of processors capable of executing instructions stored by memory resource 330. Processing resource 340 may be integrated in a single device or distributed across devices. Further, memory resource 330 may be fully or partially integrated in the same device as processing resource 340, or it may be separate but accessible to that device and processing resource 340.

In one example, the program instructions can be part of an installation package that when installed can be executed by processing resource 340 to implement system 100. In this case, memory resource 330 may be a portable medium such as a CD, DVD, or flash drive or a memory maintained by a server from which the installation package can be downloaded and installed. In another example, the program instructions may be part of an application or applications already installed. Here, memory resource 330 can include integrated memory such as a hard drive, solid state drive, or the like.

In FIG. 3, the executable program instructions stored in memory resource 330 are depicted as plot receipt module 302, target area receipt module 304, first print module 306, quality data module 308, second print module 310, and corrective action module 312. Plot receipt module 302 represents program instructions that when executed by processing resource 340 may perform any of the functionalities described above in relation to plot receipt engine 102 of FIG. 1. Target area receipt module 304 represents program instructions that when executed by processing resource 340 may perform any of the functionalities described above in relation to target area receipt engine 104 of FIG. 1. First print module 306 represents program instructions that when executed by processing resource 340 may perform any of the functionalities described above in relation to first print engine 106 of FIG. 1, Quality data module 308 represents program instructions that when executed by processing resource 340 may perform any of the functionalities described above in relation to quality data engine 108 of FIG. 1. Second print module 310 represents program instructions that when executed by processing resource 340 may perform any of the functionalities described above in relation to second print engine 110 of FIG. 1. Corrective action module 312 represents program instructions that when executed by processing resource 340 may perform any of the functionalities described above in relation to corrective action engine 212 of FIG. 2.

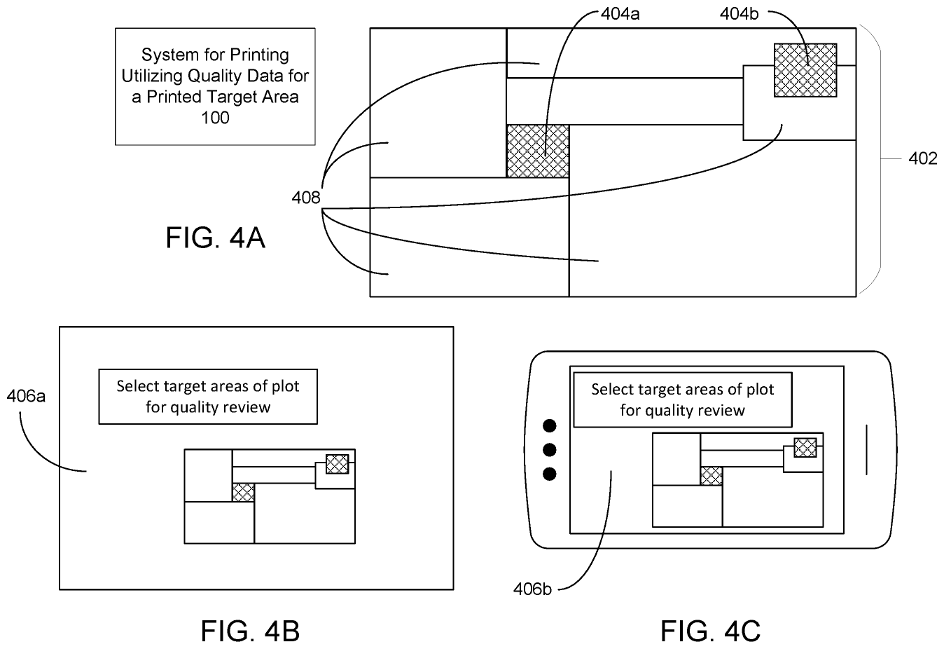

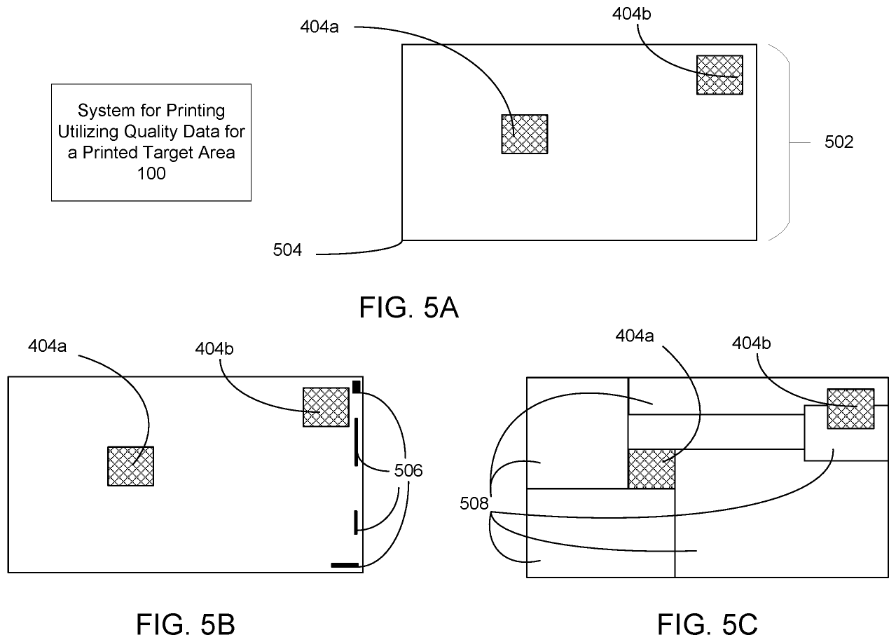

FIGS. 4A, 4B, 4C, 5A, 5B, and 5C illustrate an example of printing utilizing quality data for printed target areas. In the example of FIGS. 4A, 4B, 4C, 5A, 5B, and 5C, system for printing utilizing quality data for a printed target area 100 is to receive a plot 402 be printed at a digital printer. System 100 is additionally to receive a designation of a first target area 404a and a second target area 404b of the plot. In examples, system 100 may provide a user interface, e.g., graphic user interface 406a (FIG. 4B) or graphic user interface 406b (FIG. 4C), for a user to use designate the first and second target areas 404a 404b. In the example of FIG. 4B, the graphic user interface is included as application to be accessed at the printer. In the example of FIG. 4C, the graphic user interface is included as application to be accessed at a mobile computing device or other computing device separate from the printer yet in network communication with the printer.

Moving to FIG. 5A, system 100 is to cause a first printing 502 that is a printing onto a substrate 504 of the first target area 404a and the second target area 404b, leaving unprinted space on the substrate for subsequent printing of the non-target areas of the plot 402 (FIG. 4A). Moving to FIG. 5B, in certain examples, system 100 is to, in addition to printing of the first and second target areas 404a 40b, print one or more fiducials 506 upon the substrate 504.

System 100 is to receive quality data indicative of the quality of the printed first target area 404a and second target area 404b. In examples, such quality data may be a user quality assessment, e.g., received via a graphic user interface or other user interface for collection of quality data. In other examples, such quality data may a system generated quality assessment that is the result of a scanning of the printed first and second target areas 404a 404b utilizing a spectrophotometer or other optical sensor.

Moving to FIG. 5C, system 100 is to, if the indicated qualities of the test printings of first target area 404a and second target area 404b are above a predefined threshold, position the substrate for a second printing that is a printing of the non-target areas 508 of the plot. In examples where the first printing included fiducials 506 (FIG. 5C), system 100 is to utilize an optical sensor to detect the fiducials and is to utilize the detected fiducials in positioning the substrate for the second printing of the non-target area without printing in the target areas. Accordingly, the result of the first and second printings is to print the entire plot 402 (FIG. 4C) without overprinting of the first and second target area 404a 404b that were printed in the first printing.

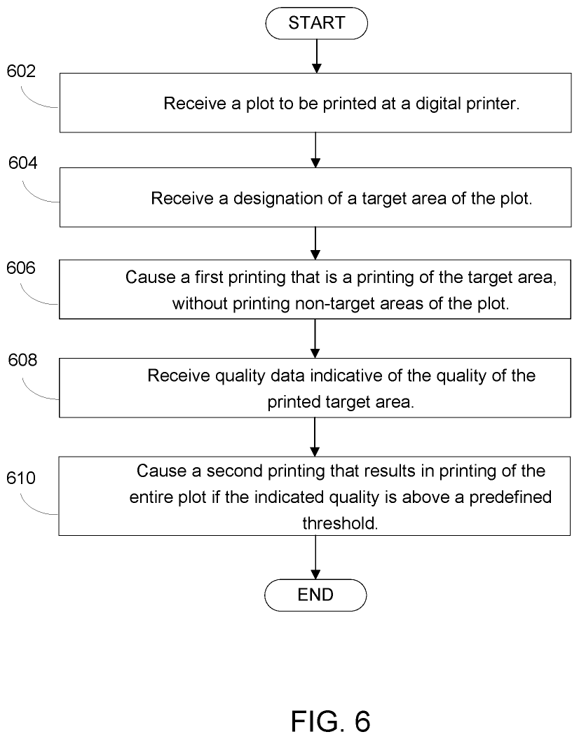

FIG. 6 is a flow diagram of implementation of a method for production of scratch-off structures. In discussing FIG. 6, reference may be made to the components depicted in FIGS. 1 and 3. Such reference is made to provide contextual examples and not to limit the manner in which the method depicted by FIG. 6 may be implemented. A plot to be printed at a digital printer is received (block 602). Referring back to FIGS. 1 and 3, plot receipt engine 102 (FIG. 1) or plot receipt module 302 (FIG. 3), when executed by processing resource 340, may be responsible for implementing block 602.

A designation of a target area of the plot is received (block 604). Referring back to FIGS. 1 and 3, target area receipt engine 104 (FIG. 1) or target area receipt module 304 (FIG. 3), when executed by processing resource 340, may be responsible for implementing block 604.

A first printing is caused. The first printing is a printing of the target area, without printing non-target areas of the plot (block 606). Referring back to FIGS. 1 and 3, first print engine 106 (FIG. 1) or first print module 306 (FIG. 3), when executed by processing resource 340, may be responsible for implementing block 606.

Quality data indicative of the quality of the printed target area is received (block 608). Referring back to FIGS. 1 and 3, quality data engine 108 (FIG. 1) or quality data module 308 (FIG. 3), when executed by processing resource 340, may be responsible for implementing block 608.

If the indicated quality is above a predefined threshold, a second printing is caused. The second printing results in printing of the entire plot (block 610). Referring back to FIGS. 1 and 3, second print engine 110 (FIG. 1) or second print engine module 310 (FIG. 3), when executed by processing resource 340, may be responsible for implementing block 610.

FIGS. 1-6 aid in depicting the architecture, functionality, and operation of various examples. FIGS. 1-3 depict various physical and logical components. Various components are defined at least in part as programs or programming. Each such component, portion thereof, or various combinations thereof may represent in whole or in part a module, segment, or portion of code that comprises executable instructions to implement any specified logical function(s). Each component or various combinations thereof may represent a circuit or a number of interconnected circuits to implement the specified logical function(s). Examples can be realized in a memory resource for use by or in connection with a processing resource. A “processing resource” is an instruction execution system such as a computer/processor based system or an ASIC (Application Specific Integrated Circuit) or other system that can fetch or obtain instructions and data from computer-readable media and execute the instructions contained therein, A “memory resource” is a non-transitory storage media that can contain, store, or maintain programs and data for use by or in connection with the instruction execution system. The term “non-transitory” is used only to clarify that the term media, as used herein, does not encompass a signal. Thus, the memory resource can comprise a physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory (EPROM), flash drives, and portable compact discs.

Although the flow diagram of FIG. 6 shows specific orders of execution, the order of execution may differ from that which is depicted. For example, the order of execution of two or more blocks or arrows may be scrambled relative to the order shown. Also, two or more blocks shown in succession may be executed concurrently or with partial concurrence, Such variations are within the scope of the present disclosure.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein. All of the features disclosed in this specification (including any accompanying claims, abstract and drawings), and/or all of the blocks or stages of any method or process so disclosed, may be combined in any combination, except combinations where at least some of such features, blocks and/or stages are mutually exclusive. The terms “first”, “second”, “third” and so on in the claims merely distinguish different elements and, unless otherwise stated, are not to be specifically associated with a particular order or particular numbering of elements in the disclosure.

What is claimed is:

1. A method for printing utilizing quality data for a printed target area, comprising:
receiving a plot to be printed at a digital printer;
receiving a designation of a target area of the plot;
causing a first printing that is a printing of the target area, without printing non-target areas of the plot;
receiving quality data indicative of the quality of the printed target area; and
if the indicated quality is above a predefined threshold, causing a second printing that results in printing of the entire plot.

2. The method of claim 1, further comprising if the indicated quality is below a predefined threshold, performing a corrective action to improve the quality.

3. The method of claim 1,
wherein the first printing includes leaving unprinted space on the substrate for subsequent printing of the non-target areas of the plot;
further comprising causing the printer to position the substrate for the second printing; and
wherein causing the second printing includes printing the non-target areas without printing in the target area.

4. The method of claim 3, wherein causing the first printing includes printing a fiducial upon the substrate, and wherein causing the printer to position the substrate for the second printing includes utilizing an optical sensor to detect the fiducial.

5. The method of claim 1,
wherein the plot is a first plot and the target area is a first target area;
further comprising receive a designation of a second target area of the first plot;
wherein the first printing is a disposable printing, and includes creating and printing a second plot including the first and second target areas of the first plot printed adjacent to one another; and
wherein the second printing is a production printing of the first and second target areas and the non-target areas.

6. The method of claim 1, further comprising providing a user interface for the user to designate the target area, and wherein the designation of the target area is a user designation received via the user interface

7. The method of claim 1, wherein the designation is a designation made by an application according to predefined criteria for the target area.

8. The method of claim 1, wherein the quality data is data provided by a user via a user interface.

9. The method of claim 8, wherein the predefined threshold is a user assessment that that the quality is at or above satisfactory.

10. The method of claim 1, further comprising utilizing a camera to capture an image of the printed plot, and creating the quality data by comparing a measured value of the captured image with an expected value.

11. A memory resource storing instructions that when executed are to cause a processing resource to print a plot in consideration of quality data for a printed target area, comprising:
a plot receipt module that when executed is to receive a plot be printed at a digital printer;
a target area receipt module that when executed is to receive a designation of a target area of the plot;
a first print module that when executed is to cause a first printing that is a printing of the target area, without printing non-target areas of the plot;
a quality data module that when executed is to receive quality data indicative of the quality of the printed target area; and
a second print module that when executed is to, if the indicated quality is above a predefined threshold, cause a second printing that results in printing of the entire plot.

12. The memory resource of claim 11, wherein the designation of a target area of the plot received by the target area receipt module is a designation originating from a user interface.

13. The memory resource of claim 11, wherein the designation of a target area of the plot received by the target area receipt module is a designation provided by an application according to predefined criteria for the target area.

14. The memory resource of claim 11, wherein the quality data received by the quality data module is data that was created by comparing a value of the printed target area measured using a camera with an expected value.

15. A system for printing utilizing quality data for a printed target area, comprising:
an optical sensor;
a plot receipt engine to receive a plot be printed at a digital printer;
a target area receipt engine to receive a designation of a target area of the plot;
a first print engine to cause a first printing that
is a printing of the target area, leaving unprinted space on the substrate for subsequent printing of the non-target areas of the plot, and
includes a fiducial printed upon the substrate;
a quality data engine to receive quality data indicative of the quality of the printed target area;
a corrective action engine to, if the indicated quality is below a predefined threshold, performing a corrective action to improve the quality;
a second print engine to, if the indicated quality is above a predefined threshold,
utilize the optical sensor to detect the fiducial and position the substrate for a second printing utilizing the detected fiducial; and
cause the second printing of the non-target areas without printing in the target area, such that the result of the first and second printings is to print the entire plot without overprinting of the target area.
